(19) United States
(12) Patent Application Publication
(10) Pub. No.: US 2026/0357786 A1
(43) Pub. Date: Nov. 12, 2026

(54) COMPRESSED AIR ENERGY STORAGE AND DISTRIBUTION PIPELINE FOR AIR COOLING SYSTEM AND METHOD

(71) Applicant: Breeze Inc., Albuquerque, NM (US)

(72) Inventors: Christopher Edward CONNORS, Hampton, NJ (US); Michael Steven ORSHAN, Albuquerque, NM (US); Denis Raymond WIART, Sturgeon County (CA)

(21) Appl. No.: 19/446,389

(22) Filed: Jan. 12, 2026

Related U.S. Application Data
(63) Continuation-in-part of application No. 17/552,770, filed on Dec. 16, 2021.
(60) Provisional application No. 63/126,446, filed on Dec. 16, 2020.
(60) Provisional application No. 63/286,024, filed on Dec. 4, 2021.
(60) Provisional application No. 63/743,827, filed on Jan. 10, 2025.

(51) Int. Cl. F03D 9/17; F01D 15/10; H02K 7/18

(52) U.S. Cl. CPC F03D 9/17; F01D 15/10; H02K 7/1823; F05B 2220/706

(57) ABSTRACT

The present invention involves storage of energy with compressed air into a compressed air microgrid enabling localized energy systems to be deployed without straining conventional existing electrical grids. A network of powerhoods may be established for supporting a plurality of buildings, with the network having a source of compressed air; a piping system; and powerhoods coupled to the piping. Buildings are coupled to each powerhood, each powerhood having a compressed air turbine for generating electricity from electricity, and having a heat exchanger for extracting conditioned air from operation of the compressed air turbine, the heat exchanger adapted to supply the conditioned air to the buildings.

### CROSS-REFERENCE TO RELATED APPLICATIONS

The present application claims priority under 35 U.S.C. § 119(e) of United States Provisional Patent Application Ser. No. 63/743,827, filed Jan. 10, 2025; and is a continuation-in-part of U.S. patent application Ser. No. 17/552,770 , filed Dec. 16, 2021, which claims priority under 35 U.S.C. § 119(e) of United States Provisional Patent Applications Serial Numbers 63/286,024 and 63/126,446, filed Dec. 4, 2021, and Dec. 16, 2020, respectively; the disclosures of which are incorporated by reference herein.

### BACKGROUND

### Field of the Invention

The field of the invention is that of energy storage and distribution. More particularly, the invention deals with energy storage and distribution using compressed air cool air systems.

### Description of the Related Art

Compressed-air energy storage (CAES) is a way to store energy generated at one time for use at another time using compressed air. At utility scale, energy generated during periods of low energy demand (off-peak) may be stored and then released to meet higher-demand (peak load) periods. For example, geological storage locations (such as salt mines and other subsurface formations) may be used to store the compressed-air in large quantities.

The growth of solar, wind, and other renewable energy resources continues to increase the supply of energy generation, but often such sources are generated at intermittent times, and at locations that may be remote from locations needing the energy. Furthermore, the location of geological storage locations may also be inconveniently positioned relative to the location of energy consumption and generation. While electrical grid management combined with CAES helps to ease the constraints of the modern energy market, further efficiencies are needed to make renewable energy sources better available and more economical.

When the air is released from the pipelines, the change in pressure can make the air feel like up to −100 C. This is due to adiabatic expansion and the laws of thermodynamics (Joule-Thomson Effect). One by-product from compressed air energy storage and transport system is cold, dry, clean air at the point of generation or release.

For example, in known systems air may cool off upon release from a CAES system in the range of −100 C to −40 C to further expand the gas/air to increase its volume and, thereby, energy production.

Annual demand for new homes is also increasing exponentially, while the ability of current electric grids is nearing full capacity. Further, conventional electrical grids are further strained by the rise in the number of data centers consuming increasing amounts of energy for computing resources and cooling of those data centers.

### SUMMARY

The present invention involves combining the storage of energy with compressed air into a compressed air microgrid enabling independent energy systems to be deployed without relying on the conventional, existing, electrical grids.

One embodiment of the invention relates to a method of distributing energy comprising creating a compressed air microgrid system. In such a system, instead of relying on conventional electricity grid connections to supply energy, a pipeline system is used to distribute energy via compressed air technology. The location of the air microgrid is independent of conventional electric grid locations, and the source of the energy generation is agnostic-it may be natural gas, solar, wind, and/or biomass. In such a system, the energy source drives an air compressor to propagate the piping system. In an air microgrid, individual users (for example, individual buildings and/or computing facilities) use the compressed air to drive turbine generators, pneumatic devices and/or provide cooling air. The piping system may be a retrofitted, repurposed system or a new pipeline.

Also, embodiments of the invention working with the transference of energy via various ways of manipulating the temperature, pressure, and rate of air flow through a pipeline, a segment thereof, pipelines or a network of pipelines. Compressed air may be used to generate heating or cooling air flows to assist various uses, including without limitation residential housing, commercial properties, greenhouses, and data centers. In embodiments of the invention, CAES systems use the −40 C turbine discharge (or other device such as a vortex tube) exhaust for industrial cooling for data centers, chillers and other applications. As many data centers require 10 MW to 50 MW of energy, 35% to 42% of their OPEX is for air conditioning and air handling to keep the computer chips cool.

The new data centers require a lot of energy, specifically for cooling. Present AI data centers are requiring 300 MW to 500 MW of energy to operate with planned AI data center campuses requiring 1 GW or more of energy. Because of the extreme heat generated by the chips or other computational devices (up to 176 F), they are being cooled by liquid, air or other methods. Liquid cooling has drawbacks as, generally, the owners want to keep liquids away from the chips. The rest of the data center and traditional chips are cooled by AC or swamp coolers.

In embodiments of the invention, providing “Compressed Air As a Service” or CAAS, the very cold air may be directly released through-out the data center. This places the AI in a closed air loop where the very cold air is released in a distributed way to cool all of the AI chips evenly but then the now warmer air is recaptured to blend back into the input to moderate temperature of the air being provided throughout the data center. By recirculating the air, the cleanliness and dryness of the air can be maintained.

Embodiments of the invention may use idle pipelines, retrofitted pipelines, repurposed or newly installed pipelines. If the data center is a campus holding multiple data centers, then embodiments may be more distributed but function the same way. Providing the cooling air involves both delivering cold air as concurrently warm air is extracted.

Embodiments of the inventions use vortex tubes and/or other mechanisms to draw heat out as well as provide the cooling air. Both air streams may then be used productively.

Further embodiments of the invention allow new residential areas to be location independent of conventional electric company facilities, wherein the provision of a new compressed air pipeline may be more efficient and effective than attempting to extend existing power grids. In addition, the compressed air pipeline microgrid may also be used to run telecommunications lines (for example without limitation fiber optic lines and/or copper communication lines) or power lines within compressed air pipelines or within the same right of way as the compressed air pipelines.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic view of a system embodiment of the present invention.

One pipeline is shown for clarity but could be connected into a network of pipelines for large scale distribution.

FIG. 2 is a cross-sectional view of a hybrid gas/compressed air turbine according to an embodiment of the present invention.

FIG. 3 is a schematic view of another embodiment of the systems of the present invention, showing direct air compression to the pipeline from the rotational motion of the wind turbine as part of the system.

FIG. 4 is a schematic diagrammatic view of a further embodiment of a dual pipeline aspect of the present invention, wherein the lower pressure pipeline is cooled by the higher pressure pipeline of compressed air.

FIG. 5 is a schematic diagrammatic view of a further embodiment of the invention augmenting a data center implantation of the present invention showing the cold air exhausted from the turbine being used to augment the cooling capacity of the cooling tower through cooling and bubbling assisted evaporation.

FIG. 6 is a schematic diagrammatic view of a further embodiment of the invention and shows a network of compressed air pipelines supplying air to a datacenter for both power and cooling as well as cooling the water in a water tower for liquid direct cooling.

FIG. 7 is a schematic representation of a CAES cooling delivery system according to one embodiment of the present invention.

FIG. 8 is a schematic diagram of a compressed air system showing inputs and outputs as used in several of the embodiments of the present invention.

FIG. 9 is an illustration of a powerhood, a smaller facility embodiment, according to this particular embodiment of the present invention.

FIG. 10 is a schematic representation of the powerhood systems of FIG. 9.

FIG. 11 is a schematic representation of a compressed air energy distribution system utilizing powerhood technology.

FIG. 12 is an enlarged view of the circled portion of FIG. 11.

FIG. 13 is a schematic diagram of an exemplary embodiment of a chiller system used in embodiments of the invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF EMBODIMENTS OF THE PRESENT INVENTION

The embodiments disclosed below is/are not intended to be exhaustive or limit the invention to the precise form disclosed in the following detailed description. Rather, the embodiment is chosen and described so that others skilled in the art may utilize its teachings.

Systems and methods of the present invention utilize existing pipelines such as petroleum pipelines, in some embodiments oil pipelines, in other embodiments gas pipelines, in other embodiments water pipelines, sewer, other types of fluid transport. In these various embodiments, energy produced at one point, for example without limitation, a renewable energy generation plant, for example solar or wind, may be stored by the energy generating devices powering air compressors which inject the generated compressed air into the pipeline system. Then, the compressed air may be utilized at a second location, possibly a great distance from the location of energy production, by a turbine being connected to the pipeline and allowing the compressed air to power a generator to create electricity or drive equipment at the second location, and optionally several additional locations.

As used in the foregoing disclosure, the term pipeline when used for compressed air transportation, transmission and storage refers to a pipeline initially fabricated for conveying fluid products, for example without limitation, oil, gas, water, sewage, which has been retrofitted for compressed air transportation and storage. The retrofitting necessary involves both cleaning and sizing the pipeline components, then establishing the necessary controls for using air. In terms of cleaning, the interior surfaces of the pipeline are processed to eliminate particulate, colloids, and liquids that might interfere with the transmission of air through the pipeline. For sizing, connections are transitioned to the sizes and shapes more suitable to compressed air system turbines and valves or other connecting equipment (for example without limitation pneumatic systems, air cooling or air heating, etc.). Additionally, the conventional fluid pipelines is tested for the pressures needed within the compressed air systems and where needed augmented, lined or otherwise retrofitted to handle compressed air rather than oil or natural gas etc.

Finally, controllers for monitoring and regulating the pressure and temperature along the pipeline to facilitate the transport and distribution of air within the pipeline, as well as the moisture and chemical composition. Further, in many situations where the outflow of the pipeline is used for turbines, air cooling, and/or pneumatic systems, the output air quality must be monitored and regulated to meet the requirements of the receiving system.

Embodiments of the invention may also use piping structures that are small in size and capacity than the pipeline structures described above. Envisioned for situations where local delivery of compressed air energy is desired, piping structures involving flexible tubes or polymer tubing may be used, and lesser pressures may be maintained. A combination of pipelines to transport larger loads of compressed air from an energy source to an energy consumer and such smaller piping systems to distribute portions of the compressed air distribution to local hubs may be deployed, for example by laying trenches for the piping systems.

In such embodiments, local hubs may service a limited number of buildings (for example without limitation 2 to 4) and include both a generating turbine for receiving compressed air and generating electricity, a battery system for storing energy not used in the hub's building, and ducting to provide the cold discharge air to the buildings. A new construction may have an initial large energy generation site, for example without limitation, a natural gas turbine, a wind farm, and/or a solar farm, to drive air compressors feeding a pipeline. The pipeline may then be connected to a several piping structures connected to several hubs so that a new construction site of multiple building could be quickly powered without having to connect to existing electrical grids.

In some embodiments, a natural gas pipeline system originally configured for distributing natural gas to residential, commercial, and light industrial facilities may be retrofitted to accommodate compressed air. While natural gas pipelines have the closest analog to compressed air systems, retrofitting is necessary for maintaining internal conditions, and the end uses are also modified. For example, a small electrical generation turbine may be coupled with a residential electrical system to provide a residence with electrical power, either as a primary or supplementary source. In another exemplary embodiment, an industrial facility may use the compressed air source for supplying pneumatic systems used at the facility. In a further exemplary embodiment, a commercial facility may use cool compressed air to cool computing equipment used in the facility. A retrofitted natural gas system may then be reused for supplementing the electrical grid or alternatively providing an air source for pressure, cooling, or heating.

Further embodiments have options that enhance the efficiency and economy of the compressed air energy storage. For example without limitation, wind turbines may directly drive DC generators or solar panels may provide direct current (DC) to DC air compressor drives so that the energy consumed by conversion to alternating current may be avoided. In addition, heat exchange generators, for example without limitation Stirling engines and Organic Rankin Cycle systems may be coupled to the air compression systems to utilize the heat generated from compression for additional energy capture for power generation or other uses. Thermovoltaic systems that use heat to generate electricity, or vortex tubes may also be added to the system to improve efficiency.

Embodiments of the inventions utilize several forms of capturing energy with compressed air. For example, without limitation, a conventional wind turbine may be coupled to an air compressor so that the wind energy is directly converted to compressed air (either with the turbine directed connected to the input shaft of the air compressor, or through a clutched system allowing for the wind turbine to alternatively drive an electricity generator or an air compressor). Similarly, a process driven turbine may be directly or clutch coupled to an air compressor. In such exemplary embodiments, the energy source may directly drive the air compressor. Further embodiments may monitor the efficacy of wind turbines, and when the natural wind makes the wind turbine inefficient, stored compressed air may then be used as an additional motive force for the wind turbines to keep them running at an acceptable efficiency. In further embodiments, the air compressor being driven by the turbine may be connected by piping to a pipeline. This piping may be structurally integrated with the support structure for the wind turbine.

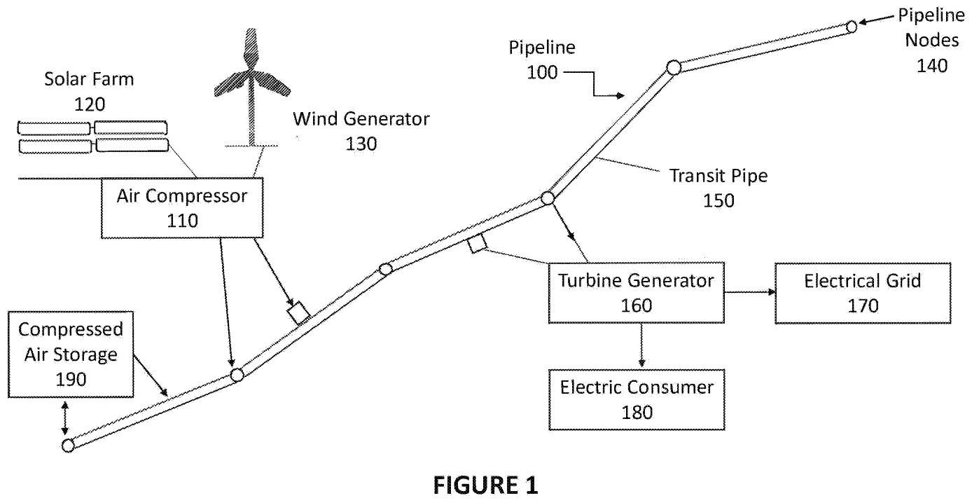

In further embodiments of the invention, the electrical generation by compressed air turbines also generates an exhaust stream of cooling air, for example without limitation, air capable of providing significant cooling to data centers, industrial refrigeration, and/or residential cooling. FIG. 1 shows one embodiment of the present invention. Systems and methods of the present invention use Pipeline 100 to accept compressed air from air compressor 110, which may be powered, for example without limitation, by solar farm 120 and/or wind generator 130. Pipeline 100 comprises a plurality of pipeline nodes 140 connected by transit pipes 150, and access for the acceptance and/or discharge of compressed air may occur at a node or alternatively directed into one of the transit pipes. For purposes of the present disclosure, a reference to a “pipeline” encompasses not only a single pipeline but also a segment of a pipeline, multiple pipelines including a network of pipelines. Once compressed air is loaded into pipeline 100, energy may be generated by turbine generator 160 to produce electricity that then may be introduced into electrical grid 170 for further distribution, or directly to electrical consumer 180. In some embodiments, compressed air storage 190, for example without limitation an underground salt cavern, another pipeline or a storage tank, may be used to absorb excess compressed air as well as introduce further compressed air into pipeline 100. Other facilities may comprise a node, for example without limitation a light industrial facility with pneumatic systems may utilize the compressed air from one of nodes 140 to power a pneumatic system. Alternatively, another one of nodes 140 may have temperature regulation so that heated or cooled compressed air is provided to a commercial facility for heating or cooling purposes.

In such a system, compressed air may be used to produce electricity with turbine generator 160, and alternatively be configured to provide compressed air to a hyperloop system for motive energy or air bearings allowing for efficient transport of product or people. For example, without limitation, product packages, instead of people in pods. (see https://virginhyperloop.com/).

Another efficiency achievable through embodiments of the present invention involve the transmission of electricity from renewable energy sources (e.g., solar farms, wind farms, etc.) to electricity consumers which often results in overheating of transmission lines. Such overheating may be mitigated by locating the transmission lines proximate or inside lower pressure compressed air pipelines, allowing the lower pressure and temperature air to dissipate the excess heat and then use that heat to improve the efficiency of the system. The low pressure pipeline may receive compressed air from a low pressure compressor, from another pipeline's release of higher pressure air or exhaust from a generator turbine or vortex tube.

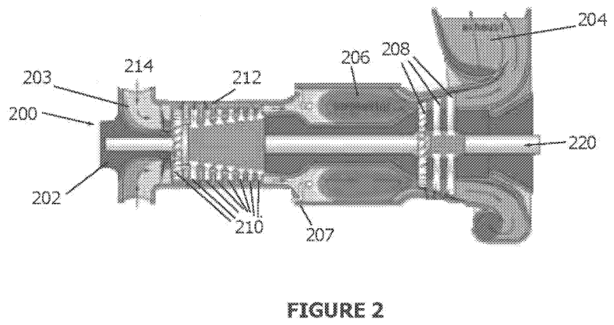

Embodiments of the invention may further enhance conventional energy generation systems. For example, without limitation, compressed air may be used to enhance the driving force for gas turbines, in effect a hybrid turbine that utilizes both combustion of natural gas and the motive energy of released compressed air to drive electrical generation, or as a black start for such a turbine. FIG. 2 shows hybrid turbine 200 according to one embodiment of the invention. Turbine body 202 combines aspects of a conventional gas turbine generator, air inlet 203, exhaust outlet 204, and combustor 206 that drive blades 208 which are rotationally coupled with turbine shaft 220, with additional blades 210 disposed in air assist portion 212 disposed advance of combustor 206 in the air flow of turbine 200. In operation, compressed air is introduced from compressed air source 214 into inlet 202, supplementing or replacing the shaft compression blades 210. Air flowing through portion 212 then enters combustor 206 and mixes with fuel (e.g., hydrogen or natural gas) from fuel inlet 207 to combust in combustor 206, creating further flow to drive turbine blades 208, also rotationally couple to turbine shaft 220, and then exit through exhaust 204. Similar designs may be utilized in coal, oil, wood pellet, or other turbine systems.

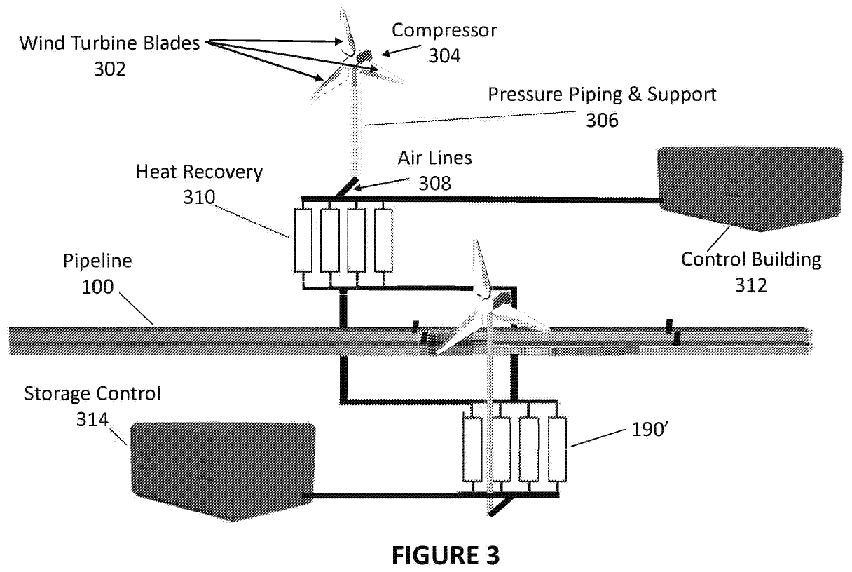

FIG. 3 shows an embodiment of the system of the present invention with wind turbine blades 302 being coupled with air compressors 304, either directly to the wind turbine shaft (not shown) or with a clutch (not shown). Wind turbine pressure piping and support tower 306 has air lines 308 to provide compressed air to heat recovery 310, which then is coupled with pipeline 100′. In such a system, control building 312 may include hydraulic or electrical control items, including but not limited to a controller, server, or other computing machinery, in conjunction with sensors disposed in and around the various components of the system, to monitor, operate and control the compressed air and/or heat recovery systems to assist energy usage efficiency and maintain pipeline pressures. Tower 306 may be hollow, in which case it may be retrofitted to contain pressurized air and then be able to store compressed air and then pass it to pipeline 100.

In another exemplary embodiment, a local consumer of electricity that also requires cooling, such as a data center or industrial facility may need both electricity for the data storage or industrial devices and heat dissipation at the facility. Coupling a data center with pipeline 100 to utilize its compressed air may involve both electricity generation by turbine generator 160 and the use of expelled, cold compressed air to cool data storage devices. Compressed air may be released to off-taker directly for industrial use rather than just as an exhaust by-product. Many industrial sites use compressed air for various product processes that benefit receiving a pipeline of compressed air. For example, an ammonia processing plant may use gas compressors to generate compressed air at about 500 pounds per square inch (PSI) as part of the process to make the ammonia, and thus could directly use compressed air from the pipeline instead of using electricity to generate their own. Many existing pipelines traverse directly to and/or through industrial parks that have a need for compressed air. Other industrial parks may desire more local electricity generation to mitigate against grid imbalances adversely impacting operations, thus desiring electric generation power plants close to those parks. Such industrial parks may also desire to use a pipeline's off-take heat and cool exhaust, electricity and direct compressed air for more extreme coolness or to operate industrial equipment that run on compressed air. Vortex tubes may also be used to convert compressed air into a cooling stream.

In some embodiments, a controller with a sensor (such as described with control building 312) may be used in compressed air storage 190 to monitor the internal pressure within pipeline 100 so that optimal pressure range may be maintained within pipeline 100 for the transmission and conversion of energy with the compressed air. Such a controller may activate an alarm or send notifications as the pressure reached certain levels so that compression and generation equipment may be activated or deactivated. Such an arrangement enables management of the energy through “energy arbitration” (i.e. storage of energy during lower demands for retransmission during peak periods, so that inexpensive electricity may be generated later at points of higher demand). Further, such arrangements may be implemented to maintain minimum and maximum pressures to protect the pipeline and maintain production efficiency. Such a system provides the ability to black start and dispatchable energy generation to augment the above ground electricity grid, or supply emergency power should grid based electricity become unavailable. For enterprises with their own power plant directly fed from the pipeline, the system provides both backup power and black start services (black start meaning being able to begin to generate electricity without having electricity from the grid available).

Such enterprises may still maintain a separate interconnect for electricity supply from the grid to be used by the enterprise for energy management similar to energy arbitration for an electric utility.

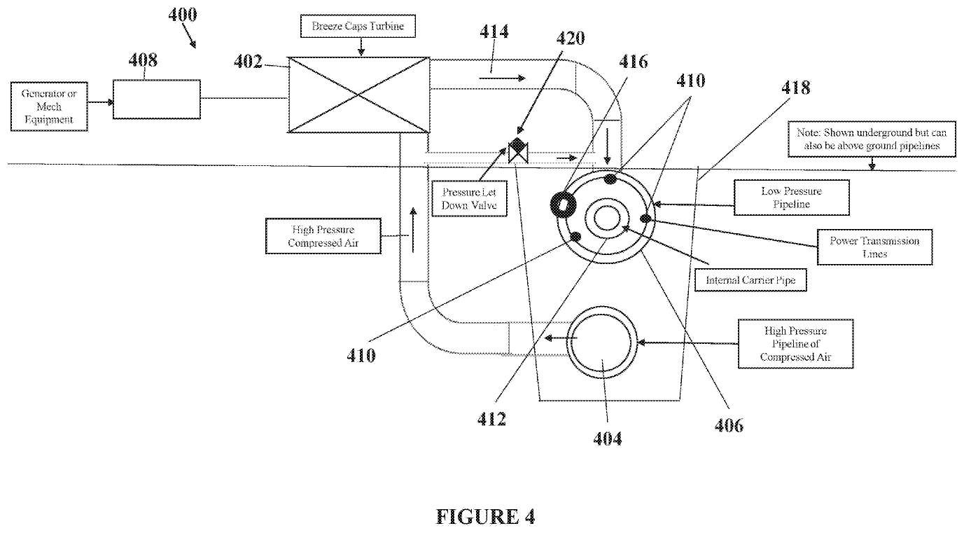

FIG. 4 shows an alternative embodiment of the invention using a dual pipeline system and method. In this embodiment, system 400 includes pressure turbine 402 which is coupled to both high pressure pipeline 404 and lower pressure pipeline 406. In one embodiment, high pressure air from pipeline 404 drives turbine 402 to generate energy derived from the release of the high pressure air to equipment 408, for example without limitation an electrical generator, a mechanical system like a pump or turbine drive, etc. Cold air discharge from turbine 402 may be provided to low pressure pipeline 406 to cool items within, in this example without limitation one or more transmission lines 410, for example without limitation high voltage electrical lines, electrical telecommunications lines, or fiber optic lines. Alternatively, cold air discharge from turbine 402 may be used by optional heat exchange system 414 to provide coolant in a post-turbine generation process. Each pipeline may have a sufficiently low temperature to moderate temperature of items disposed within the respective pipeline, and each may also be equipped with monitoring equipment 416 to enhance the security of system 400.

Low pressure pipeline 406 may further include internal carrier pipe 412 which may house further power lines, carrier pipes with other commodities, or cooling fluids for distribution. Pipelines 404 and 406 may be disposed in trench or above ground pipeline corridor 418. For purposes of the present disclosure either term “trench” or “corridor” shall mean the location where a pipeline may be disposed, either below ground or above ground, and any associated physical structures to support the pipeline. Conventionally, local regulations govern where pipelines may be located and used, so that any pipelines that are retrofitted may access a permitted use under the local regulations, so that the retrofitting and additional permitting, where required, is also relatively standard.

Additional cooling may be provided by pressure let down stations such as pressure let down valve 420 or similar device, which in some embodiments may include a vortex tube. Monitoring equipment 416 may be disposed to monitor for predetermined conditions, such as an elevated temperature in low pressure pipeline 406, to activate pressure let down valve 420, or similar device. Additionally, monitoring equipment 416 may be configured to include temperature, pressure, flow, leaking, air consumption, conductivity, noise, or other sensors to ensure proper functioning, control and security, including controller equipment to send alarms and/or implement responses to sensed disturbances to system 400. System 400 may be disposed without pressure let down valve 420, alternatively pressure let down valve 420 may be disposed in several locations, such as along any portion of transit pipe 150 of FIG. 1, including any of the nodes 140.

Embodiments of the invention may be utilized in a variety of contexts. For example, without limitation, security installations (for example without limitation, military bases, emergency responders, etc.) within a prescribed distance (for example without limitation within several hundred miles) may desire a shared closed loop system of energy sharing and communication distribution, in some embodiments located underground. In one such disposition, perhaps one node of the shared system includes a first node that only obtains its electrical power from the conventional grid and needs 14 days energy resilience, with a second node having solar generation that can provide for 150% of its power needs when the sun is out, with a third node that has either a diesel or mini nuclear power plant that provides all of its energy needs plus surplus for the other nodes but not enough to provide for all 4 of the other bases at peak, and finally fourth and fifth nodes having mixed renewable energy sources of wind and solar that each provide 100% of their peak power needs under ordinary circumstances. Under this situation the only points of ingress and egress for energy and communications through an implementation of system 400 have an integrated and redundant system. For some longer stretches, pressurized air may be directly released from the existing pipeline to low pressure pipeline 406 for cooling. The nodes may share energy by the electrical cable or through high pressure pipeline 404 and all may store excess energy production (including the first node from the grid if desired). The existing pipeline houses a communication fiber network as one of transmission lines 410 that enables secure communications one to one, one to many, many to one and many to many for command and control purposes between nodes as well as supporting a shared energy network. With appropriate monitoring equipment 414, administrators of the system may easily monitor the integrity and security with recognition and/or correction of any compromised portion.

Another example of an implementation of system 400 may be in metropolitan areas, with a mixture of open loop distribution and communication with some closed loop options. Such a system may include hard wire, fiber, other secure communications between energy generation, distribution and user points. Such a system may be used to coordinate all points with simultaneous generation for regional black start, with energy storage and distribution in open loop for access by area residents and businesses but communication may be arranged in a closed loop, or multiple communications systems some open to the public for many to many connection, and other communications systems closed for official uses only.

A further implementation of the systems of the present invention involve data centers, which require energy bill management & resilience, hot and cold air off take, secure data transfer and secure command and control communications. Communications may be closed loop between multiple co-located data centers and used for private transfer (one to one) of data, wherein connected cloud data centers may transfer data without using the internet or phone system. Such data transfer is more secure than the phone service because it may be under the ground inside a very thick, steel pipeline protected and monitored by compressed air. Attempts to access underground communications may result in the loss of air pressure potentially triggering an alarm to thus provide additional protection and security for the communications environment.

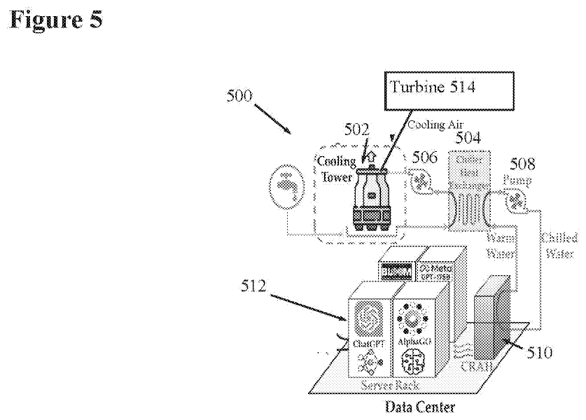

FIG. 5 shows conventional data center cooling system 500. Cooling tower 502 provides cooling water to chiller heat exchanger 504 via pump 506. Pump 508 circulates chilled water to temperature control system 510, which cools computing machinery 512 and returns warm water. In this embodiment, compressed air turbine 514 provides cooling air to augment the cooling capacity of cooling tower 502.

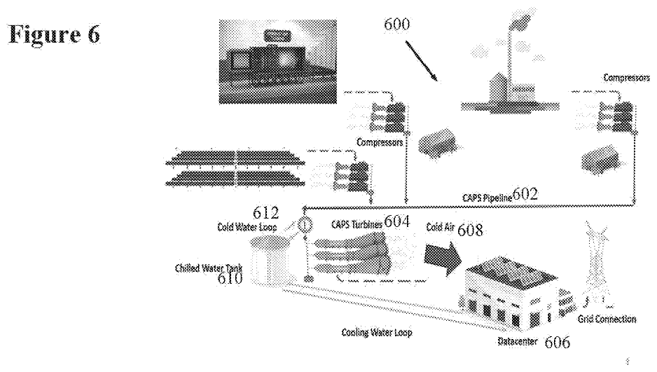

FIG. 6 shows a further embodiment of the invention involving providing cooling air directly to a data center. In FIG. 6, the top portion of the diagram shows compressed air storage and generation system 600, similar to that disclosed in FIG. 1, including pipeline 602. In addition, turbines 604 are coupled with pipeline 602 and augment temperature control for computing machinery in data center 606. Cooling for data center 606 may be accomplished by cold air supply 608, in addition to conventional chiller 610. As such, the additional cooling may be referred to as “Cold Air As a Service” (or CAAS). When air is released from pipelines, the change in pressure may lower the air temperature approaching −100 C, due to adiabatic expansion and the laws of thermodynamics (Joule-Thomson Effect), in addition to driving turbines to generate electricity. By-products of compressed air energy storage and transport include cold, dry, clean air at the point of generation. This allows for creating −40 C post electricity generation exhaust for industrial cooling for data centers, chillers and other applications. There may be chiller/heat exchange in cold water loop 612 to cool computing machinery in data center 606. Expanding through multiple stages, heat from the returning water may warm air for energy generation and be used for multiple stages. After electrical energy generation, a cold stream in the form of cold dry, clean air that is exhausted from turbines 604 is used to cool the rest of the data center. In this embodiment, −100 C air may be directly released to data center 606. Computing machinery in data center 606 is part of a closed air loop where −100 C air or warmer is released in a distributed way to cool all of the computing machinery evenly but then the now warmer air is recaptured to blend back into the input to moderate temperature of the air being provided throughout data center 606. Recirculating the air preserves the cleanliness and dryness of the air.

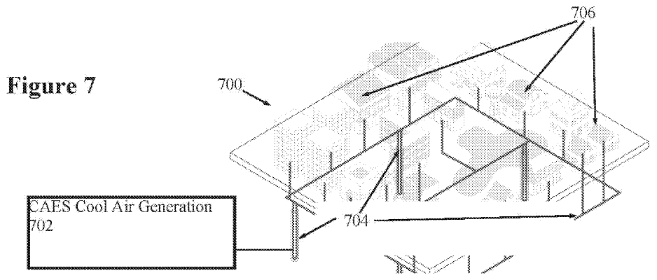

In additional to using idle pipelines as disclosed above, some embodiments of the invention may involve the installation of coils of pipelines under or in proximity to the data center or building vessels or a combination. One exemplary embodiment is shown in FIG. 7 showing campus 700 having CAES cool air generation system 702 which is coupled to underground piping system 704 which supplies cooling air to various facilities 706 of campus 700, which may be a multiple building data processing center or other applications requiring significant cooling, which allows cooling distribution over a greater number of facilities, yet functioning similarly to several of the earlier embodiments. One advantage of this embodiment is that dry cooling air is the main, if not exclusive, cooling element of the system.

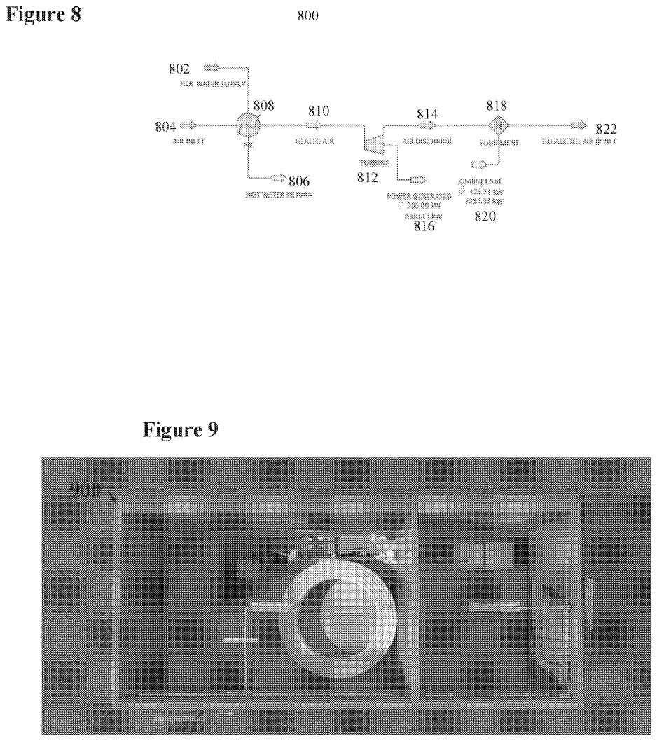

FIG. 8 is a schematic diagram of a compressed air system showing inputs and outputs that are compatible with several of the earlier disclosed embodiments. The system is designed to utilize dry air supplied through an existing pipeline network, dry air 804 being heated in heat exchanger 808 by hot water system 802/806 from a datacenter or similar heat source, and that heated air 810 is expanded through turbine 812 to generate electrical power in 816. Exhausted cooled dry air 814 is further injected as cooling media 820, for example without limitation, directly into HVAC supply 818 to computing machinery, discharged as exhaust air 822. The steps in this exemplary process are as follows: 1. Air Supply-Dry air is supplied from, for example without limitation, a 10-inch polyethylene (PE) pipeline system at specific parameters, for example without limitation, a pressure of 6 bar, a temperature of 5 °C, and a flow rate of 3.8 kg/s. This air acts as the working fluid for the heat exchanger and turbine; 2. Air Heating in the Heat Exchanger (HX)-Dry air is heated in a shell-and-tube heat exchanger by transferring heat from a hot water stream, with the hot water being supplied from an existing system at specific parameters, for example without limitation, at a temperature of 60 °C, a pressure of 3 bar, and a flow rate of 50 m³/h, with the heat exchanger operating, for example without limitation, with a heat transfer coefficient of 70 W/m^{2.}K while incurring a small pressure drop, for example without limitation, of 0.01 bar across the air stream, and the heat exchanger raising the temperature of the air to prepare it for expansion in the turbine; 3. Air Expansion in the Turbine—Heated air is routed into a single-stage turbine, where it undergoes expansion and may, for example without limitation, operate with an 80% isentropic efficiency to convert the energy from the high-pressure heated air into mechanical work, for example without limitation, generating 300 kW of electrical power; 4. Air Discharge-After expansion, the air exits the turbine at a discharge pressure, for example without limitation, of 0.05 bar with discharge air temperature ranges from −20 °C to 10 °C, depending on the operating conditions, and is directed to an existing ducting system for further cooling purposes, which after passing through the equipment inside datacenter, the exhausted dried air temperature is likely to reach, for example without limitation, approximately 20 °C; and 5. Hot Water Return-After transferring heat to the air in the heat exchanger, the hot water temperature decreases and is returned to the water system for recirculation.

This process efficiently transfers energy from the hot water system to the dry air, enabling the turbine to generate electrical power. It is designed to integrate with existing infrastructure, including the water and temperature control systems, while minimizing pressure and heat losses. By changing several of the parameters, the amount of electricity generation as compared to cooling temperature energy transfer may to varied to suit particular campuses and needs.

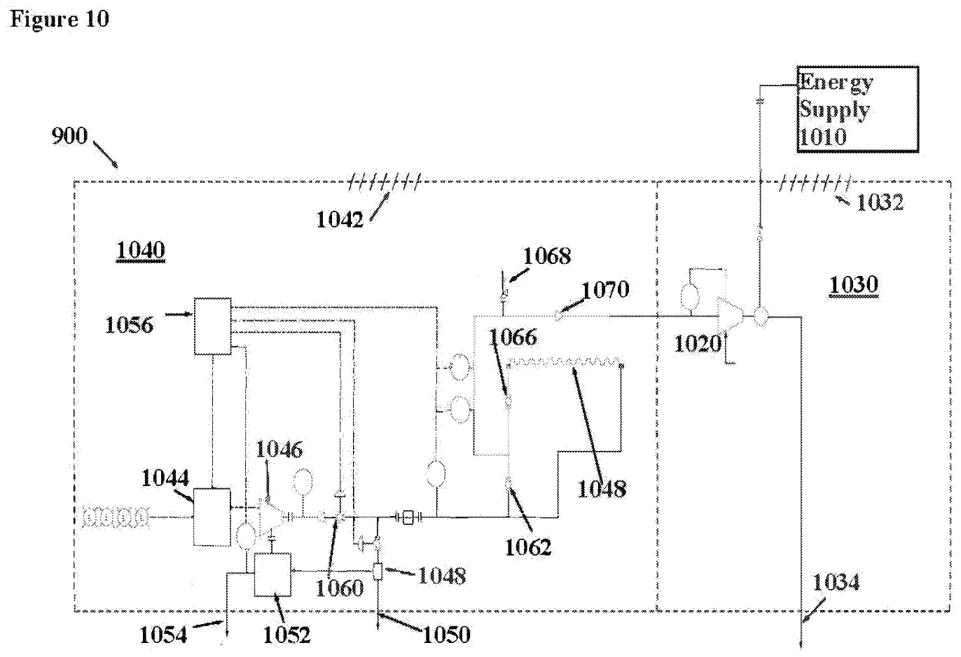

FIG. 9 shows another embodiment of the present invention. Powerhood facility 900, in this illustrated embodiment used for example and not limitation, is shown as an energy generation and transmission station housed in this exemplary embodiment in a standard sized shipping container. In this disclosure, the term “powerhood” is used to describe the embodiments of compressed air turbine based systems capable of providing both conditioned air and electricity to buildings and other facilities, a substitute for conventional electrical grids and HVAC systems, allowing for such capacities to be deployed in situations outside of conventional power systems. Other shapes and sizes of powerhood embodiments are contemplated depending on several variables including the deployment mechanisms of the powerhood, the powerhood capacity needed, the connection of the powerhood to other energy and/or compressed air sources. FIG. 10 is a schematic representation of the systems of FIG. 9. Powerhood 900 has energy supply 1010, which may be a variety of conventional energy systems. For example, without limitation, energy supply 1010 may be a natural gas tank, which may be coupled to turbine 1020 to power turbine 1020 to generate electricity and/or compress air to provide a source of energy for further processing and distribution. Hot side 1030 may have venting in the form of louver 1032 and/or exhaust line 1034. Cold side 1040 may also have louver 1042 for venting, with additional components for generated heated air, cooled air, and/or electricity for storage in battery 1044. Air turbine 1046 may be coupled with a compressed air source and with vortex tube 1048 to provide heated air through hot exhaust line 1050. Panel 1056 coordinates the operations within powerhood 900, my sending control signals to valves 1060, 1062, 1064, 1066, 1068.

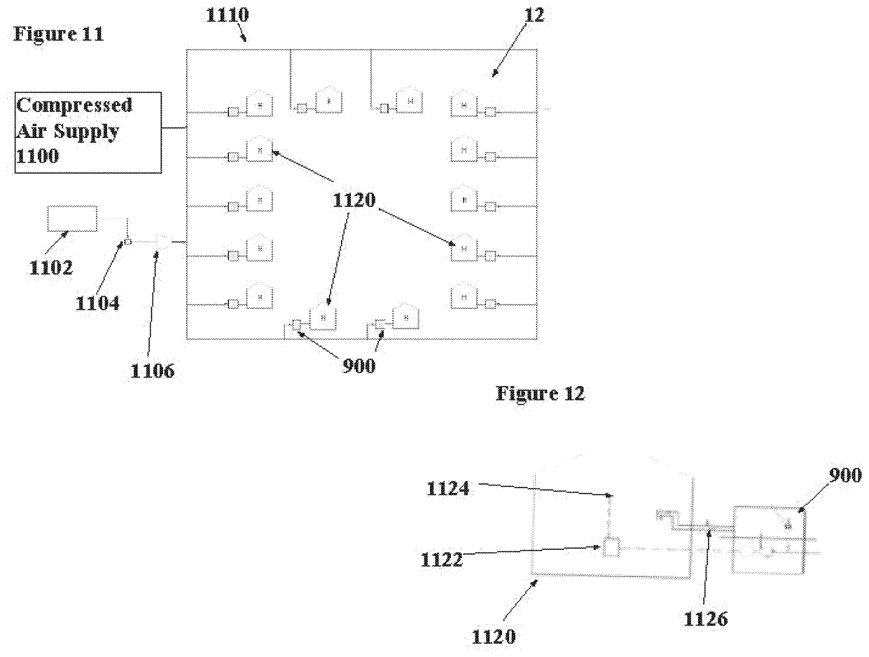

FIG. 11 is a schematic diagram of a powerhood system according to one embodiment of the invention. Muliple powerhoods 900 are coupled with neighborhood piping system 1110 to support the operations of corresponding building 1120. Piping system 1110 may be supplied with compressed air, in one embodiment, by receiving natural gas from gas utility 1102, use the natural gas to generate power in gas engine 1104, and thereby drive air compressor 1106. Alternatively, piping system may be coupled to compressed air supply 1100, for example without limitation, an underground storage, pipeline storage, or tank based storage. As a further alternative embodiment (not shown), wind, solar, and/or geothermal electrical generation systems may be used to drive an air compressor coupled with compressed air supply 1100. Compressed air is then distributed to the plurality of powerhood 900 which provide heating, cold air or refrigeration, and electricity to the corresponding plurality of buildings 1120. As shown in the breakout of FIG. 12, powerhood 900 receives compressed air to generate both electricity to charge battery 1122, to power house load 1124, or both, and conditioned air flow through air conditioning conduit 1126 to either heat and/or cool the building.

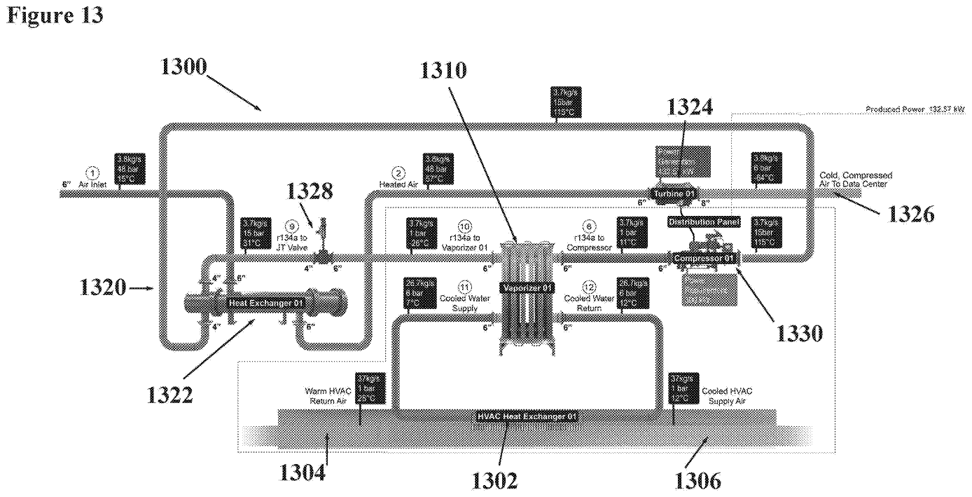

FIG. 13 shows another embodiment of the invention. In this exemplary embodiment, a specific implementation of an enhanced chiller type facility that may perform the functions of Cold Air 602 shown in FIG. 6. In this example, chiller 1300 provides both chilled water and cold air for HVAC type loads in buildings. Chiller 1300 is connected to a building HVAC system (not shown) via HVAC heat exchanger 1302, which receives warm HVAC return air at return 1304, for example without limitation, at 1 bar 28 °C and 37 kg/s, and provides cooled HVAC supply air conduit 1306, for example without limitation, at 12 °C and 37 kg/s. A conventional refrigerant chiller system may contain compressor 1330, air cooled heat exchanger 1322, JT valve 1328, and Vaporizer 1310, but the difference in this disclosed system involves the air cooled heat exchanger using compressed air from the pipeline system to cool the refrigerant versus conventional ambient air systems. Vaporizer 1310 receives cooled water from HVAC heat exchanger 1302, for example without limitation at 6 bar, 7 °C, and 26.7 kg/s, and cooled water return from HVAC heat exchanger 1302, for example without limitation at 6 bar, 12 °C, and 26.7 kg/s. Vaporizer 1310 is further coupled to refrigerant circuit 1320 having refrigerant heat exchanger 1322 which provides heated air to turbine 1324, for example without limitation at 48 bar, 57 °C, and 3.8 kg/s, for power generation, for example without limitation 432.57 KW, with the cool air discharge 1326 being provided as a cooling resource at, for example without limitation, 6 bar, −64 °C, 3.8 kg/s. Compressor 1330 may receive refrigerant fluid from Vaporizer 1310, for example without limitation at 1 bar, 11 °C, 3.7 kg/s, and may provide refrigerant to heat exchanger 1322, for example without limitation, at 15 bar, 115 °C, 3.7 kg/s. Completing refrigerant circuit 1320, heat exchanger 1322 may provide refrigerant at 15 bar, 31 °C, and 3.7 kg/s through JT valve 1328, which then may provide refrigerant fluid to Vaporizer 1310, for example without limitation, at 1 bar, −26 °C, and 3.7 kg/s. Compressed air leaves heat exchanger 1322 and feeds air driven turbine generator 1324 to produce both power and discharges cold air to the HVAC system. A single stage turbine is shown in this exemplary embodiment, but multistage or turbines in series may also be used.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A method of distributing energy comprising the steps of:
providing a piping system;
providing a source of compressed air coupled to the piping system; and
coupling a plurality of powerhoods, each powerhood capable of receiving compressed air and providing to a building both electricity and conditioned air.

2. A system for providing electricity and air conditioning for a building, the system comprising:
a turbine generator capable of generating electricity from compressed air; and
a heat exchange system capable of generating conditioned air from the operation of the turbine.

3. The system of claim 2 further including a battery coupled to the turbine generator.

4. A network for supporting a plurality of buildings, the network comprising:
a source of compressed air;
a piping system; and
at least one powerhood coupled to the piping system and at least one of the buildings, each powerhood having a compressed air turbine for generating electricity from electricity, and having a heat exchanger for extracting conditioned air from operation of the compressed air turbine, the heat exchanger adapted to supply the conditioned air to at least one of the buildings.

5. The network of claim 4 wherein at least one powerhood includes a battery.

6. A system for capturing, distributing, and using a plurality of energy systems comprised of:
a retrofitted pipeline for compressed air;
a second pipeline disposed proximately with the retrofitted pipeline, the second pipeline having an associated transmission line; and
at least one member coupled to the first and second pipelines, the member configured to receive compressed air from the retrofitted pipeline and configured to supply coolant to the second pipeline.

10. The system of claim 6 wherein the retrofitted pipeline and the second pipeline are arranged in a closed loop.

11. The system of claim 11 further comprising a plurality of nodes, wherein at least one of the nodes is connected to the electrical grid and has an air compressor configured for supplying compressed air to the retrofitted pipeline.

12. The system of claim 6 further comprising a pressure let down valve.

13. The system of claim 12 further comprising at least one turbine including a heat exchanger configured to supply discharge air for cooling in the second pipeline.

14. The system of claim 12 further including monitoring equipment.

15. The system of claim 12 wherein the retrofitted pipeline and the second pipeline are disposed in a common trench.

16. The system of claim 12 wherein the associated transmission line is one of a electrical power transmission line and a communications line.

17. The system of claim 12 wherein a plurality of associated transmission lines are disposed with the second pipeline.

18. The system of claim 17 wherein the plurality of associated transmission lines are disposed in thermal proximity within the second pipeline.

19. The system of claim 13 wherein the turbine is configured to drive an electric generator.

20. The system of claim 13 wherein the turbine is configured to drive a mechanical system.
